(19) United States
(12) Patent Application Publication
(10) Pub. No.: US 2008/0230291 A1
(43) Pub. Date: Sep. 25, 2008

(54) Supporting Structure in the Front Region of a Motor Vehicle

(75) Inventor: Dirk Kersting, Lippstadt (DE)

Correspondence Address: FOLEY AND LARDNER LLP;SUITE 500, 3000 K STREET NW, WASHINGTON, DC, 20007, US

(73) Assignee: HBPO GMBH

(21) Appl. No.: 12/091,119

(22) PCT Filed: Oct. 2, 2006
(86) PCT No.: PCT/EP2006/009537

§ 371 Date: Apr. 22, 2008

(30) Foreign Application Priority Data
Oct. 28, 2005 (DE) 10 2005 051 661.0

(51) Int. Cl. B62D 25/08

(52) U.S. Cl. 180/68.4

(57) ABSTRACT

Supporting structure (1) in the front region of a motor vehicle, with a supporting frame (13) which can be covered on the rear side by a rear wall (12) which has a fan opening (11). It is proposed that a retaining frame (3) for holding cooling components, in particular heat exchangers (4, 9), is arranged pivotably in front of the supporting frame (13) in the direction of travel.

The invention relates to a supporting structure in the front region of a motor vehicle as per the preamble of patent claim 1.

The front region of a motor vehicle is nowadays often embodied as a so-called front-end module which has a supporting structure, which is to be fastened in the vehicle, or a so-called assembly member. Fastened to the supporting structure or to the assembly member are inter alia cooling components such as various heat exchangers and/or a ventilating fan. The front-end module is fully pre-assembled and inserted as a modular unit into the motor vehicle.

DE 699 12 263 T2 has disclosed a front-end module for a motor vehicle which has a supporting structure in which inter alia a coolant cooler is held and fastened. The fastening takes place by means of a frame which on the one hand holds the cooler and on the other hand is fixedly connected to the supporting structure. In the event of the cooler being exchanged—for example for repair purposes—said cooler must be removed in the forward direction, which demands additional installation space in the direction of travel.

U.S. Pat. No. 6,685,258 B2 has disclosed a supporting structure for a front-end module to which is fastened a fan frame. Said document discloses nothing regarding the arrangement of heat exchangers such as for example a coolant cooler or a condenser.

It is also known to combine cooling components in the form of heat exchangers to form a modular unit, to form a cooling module or a so-called cooling cassette, and for said cooling components to be supported directly with respect to the vehicle structure.

DE 41 42 023 C2 has disclosed a heat exchanger unit for motor vehicles with a frame composed of plastic, a so-called cassette, in which various heat exchangers such as a coolant cooler, a condenser and the like are held and retained. The cassette with the heat exchangers has, at the end side, struts for retaining the heat exchangers and, at the side, brackets with bearing journals, by means of which the entire cassette including the heat exchangers is supported in the vehicle, that is to say on the vehicle structure.

DE 39 22 814 C2 has disclosed a similar cooling cassette into which a cooler block of a cooler is inserted in the manner of a drawer or “in the manner of a cassette”. The entire cassette or the holding and guiding frame for the cooler block is fixedly fastened to the vehicle structure.

It is an object of the present invention to fasten cooling components, in particular heat exchangers, to a supporting structure of the type specified in the introduction in a simple and cost-effective manner, wherein simple dismounting of the heat exchangers should also be possible.

Said object is achieved by means of the features of patent claim 1. According to the invention, it is provided that a holding frame for holding cooling components is pivotably arranged in front of the supporting frame in the direction of travel. The pivot axis is preferably situated in the lower region of the holding frame, which holding frame advantageously has two lateral pivot journals which are held in corresponding bearings on the supporting structure. The pivotable holding frame can therefore be inserted into the bearing from top to bottom in a slightly inclined position, and can then be pivoted toward the supporting structure or the supporting frame. Corresponding fastening means, for example in the form of a clip connection, are provided for fastening on the holding frame and on the supporting frame, which fastening means can also be easily released again. The holding frame advantageously has lateral guide means which permit an insertion of the heat exchanger into the holding frame from above—in the manner of a drawer or a cassette. It is likewise possible for the heat exchanger to be removed when the holding frame is pivoted away. An advantage of the pivotable holding frame according to the invention is the simple fastening of the heat exchanger in the frame, which takes place in a virtually form-fitting manner. This is advantageous in particular in the case of fully metal or fully aluminum heat exchangers, for example a refrigerant condenser or a coolant cooler, because the attachment of additional fastening means is dispensed with in this case. This entails a cost saving, since the fastening means cannot—as in the case of plastic collecting tanks—be injection-molded on, but rather must be soldered on. The pivoting-to and pivoting-away additionally result in a simple assembly and disassembly capability, in particular in the event of repairs.

In one advantageous embodiment of the invention, the holding frame is designed, on its inner side, that is to say in contact with the heat exchangers, such that sealing takes place and the air does not pass the heat exchanger as bypass air or so-called false air.

In a further advantageous embodiment of the invention, the holding frame is also formed on the outer side such that sealing takes place with respect to the supporting structure or the supporting frame. Complete peripheral sealing is thereby provided.

According to a further advantageous embodiment of the invention, a further guide shaft is arranged in the lower region of the holding frame, which further guide shaft can hold an additional heat exchanger, for example a charge-air cooler, which makes up only a part of the entire end face.

The holding frame can advantageously be produced as a single-piece plastic injection-molded part, that is to say including the lateral guide elements, the bearing and the fastening elements for the pivoted-to position. The production as a plastic injection-molded part therefore permits precise adaptation of guide tracks, with regard to their cross section, to the heat exchanger to be used, for example a fully-aluminum coolant cooler with box-shaped coolant tanks and a condenser with cylindrical collecting tubes.

Although the pivotable fastening of the holding frame preferably takes place to a supporting structure as is provided for a front-end module, that is to say to a so-called assembly member, this does not exclude the possibility of a fastening according to the invention also taking place directly to a supporting structure of the motor vehicle, for example to the front wall thereof.

An exemplary embodiment of the invention is illustrated in the drawing and is described in more detail below. In the drawing:

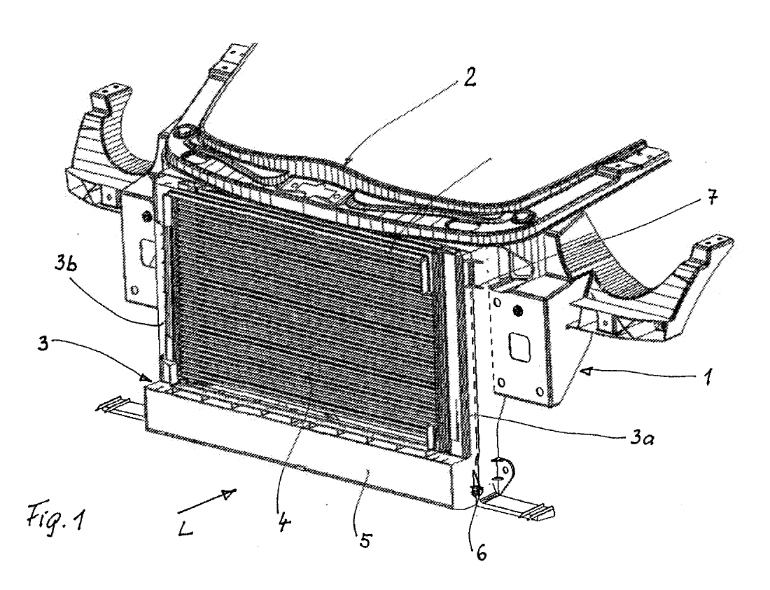

FIG. 1 shows a supporting structure with a holding frame according to the invention pivoted to,

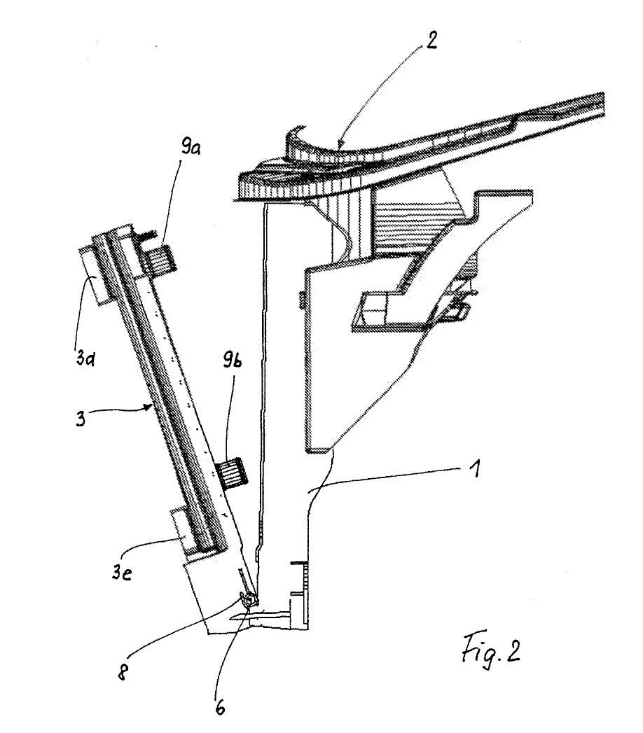

FIG. 2 shows the supporting structure with the pivotable holding frame pivoted away, in a view from the side,

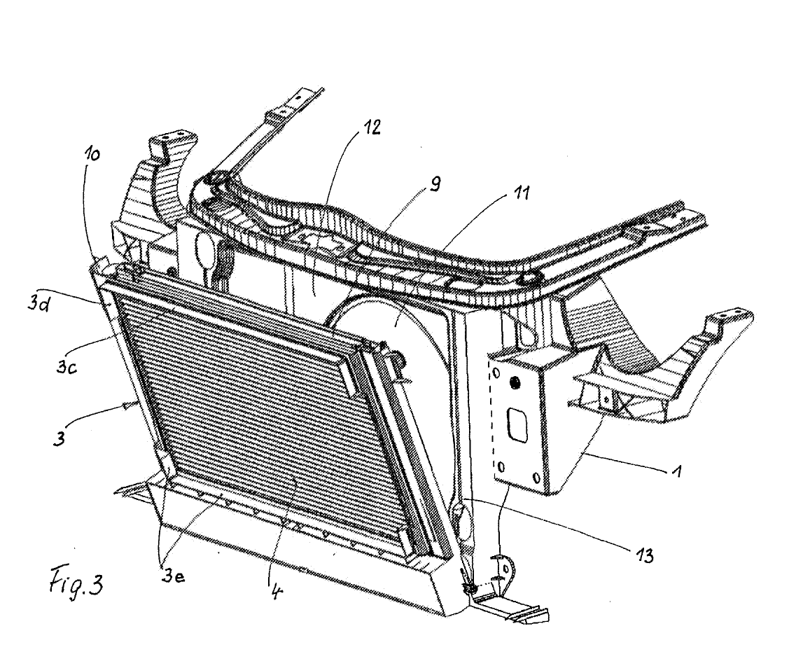

FIG. 3 shows the pivoted-away holding frame with the supporting structure, in a 3D illustration,

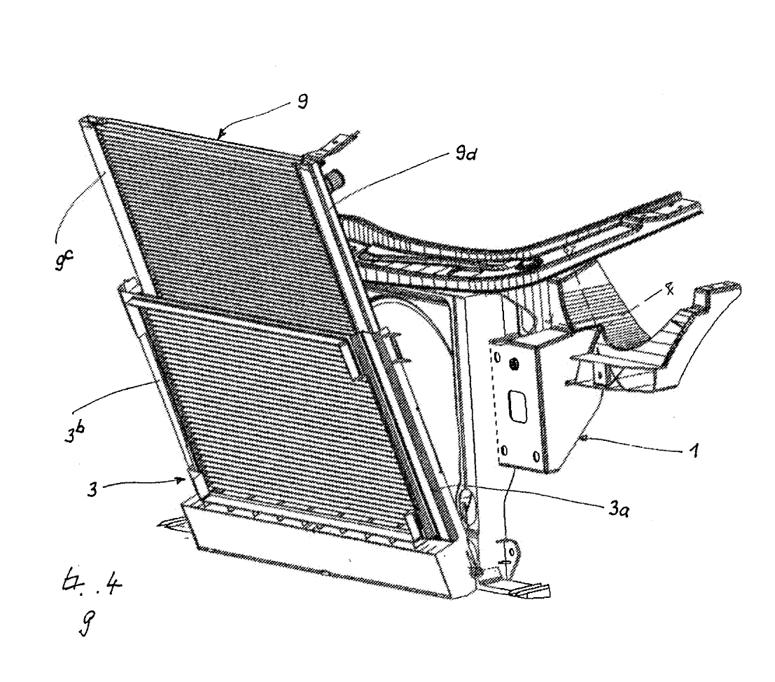

FIG. 4 shows the pivoted-away holding frame with the coolant cooler partially pulled out, and

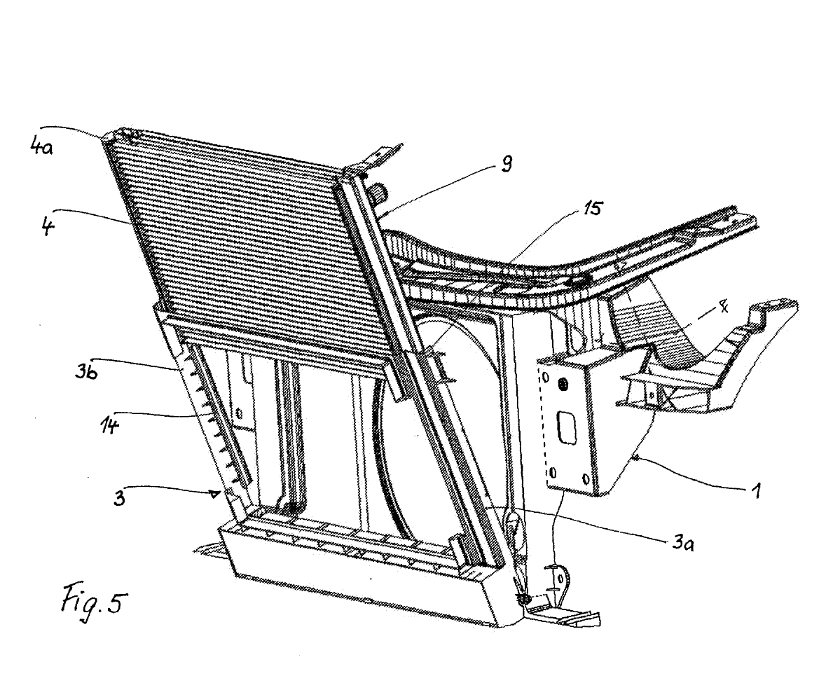

FIG. 5 shows the pivoted-away holding frame with the coolant cooler pulled out and with the condenser pulled out.

FIG. 1 shows a supporting structure, which is embodied as an assembly member 1, for a front-end module of a motor vehicle (not illustrated). Arranged above the assembly member 1 is a transverse member 2, a so-called lock member, which is connected to the body of the vehicle in a way which is not illustrated. The assembly member 1 is likewise connected to the body of the vehicle, for example to longitudinal members (not illustrated). Arranged in front of the assembly member 1 (as viewed in the direction of travel) is a holding frame 3, which holding frame 3 is pivotably connected to the assembly member 1. The holding frame 3 holds a plurality of heat exchangers, inter alia a condenser 4, whose end face is fully exposed by the rectangular holding frame 3 and can be impinged on by a flow of ambient air in the direction of the arrow L. The holding frame 3 has two lateral beams, longitudinal beams 3a, 3b, which are connected at their upper ends by means of a transverse strut 3c. The lower region of the holding frame 3 has a guide shaft 5 which (as viewed in the flow direction) is open at the front and at the rear and into which a further heat exchanger (not illustrated), for example a charge-air cooler, can be inserted. A pivot journal 6 is arranged on the longitudinal beam 3a in the lower region, which pivot journal 6 is held by a bearing (not visible here) on the assembly member 1. Arranged in the upper region of the longitudinal beam 3a is a fastening element 7 which is preferably embodied as a part of a clip connection. Situated on the opposite longitudinal beam 3b are—though not visible in this illustration—corresponding fastening elements 6, 7. The holding frame 3 is, in the illustration, situated in the pivoted-to position, that is to say it is—in the installed state in the motor vehicle—aligned substantially vertically and ends with the assembly member 1. In addition, the holding frame 3 is also—though not illustrated—sealed off with respect to the assembly member 1—preferably at the end side—so that no air—so called false air—can flow around the heat exchanger so as to bypass the latter.

FIG. 2 shows the assembly member 1 and the holding frame 3 in the pivoted-away position, in a view from the side. The laterally arranged pivot journal 6 is held in a U-shaped, upwardly open pivot bearing 8 which is fastened to the assembly member 1. The holding frame 3 can therefore, in the illustrated position, be hooked into the two pivot bearings 8 from top to bottom and subsequently pivoted to, that is to say pivoted toward the assembly member 1. In the upper and lower region, the holding frame 3 has air guiding elements 3d, 3e which guide the air flow in the direction of the heat exchanger. Arranged downstream of the already-mentioned condenser in the air flow direction is a coolant cooler 9 (not visible here) of which only the coolant connections 9a, 9b can be seen.

FIG. 3 shows the holding frame 3 in a pivoted-away position with respect to the assembly member 1 in a perspective illustration, with an upper insertion opening 10 for the two heat exchangers 4, 9 being visible. The coolant cooler 9, which is arranged downstream of the condenser 4 in the air flow direction, is embodied as a fully-aluminum heat exchanger, that is to say as a fully-soldered component. The air guiding elements 3c, 3d, 3e can also be clearly seen in this perspective. Arranged in the assembly member 1 is an opening 11 in which a fan (not illustrated) revolves. The assembly member 1 is also closed off at the rear side by a rear wall 12, a so-called fan frame. The assembly member 1 has, in its central region, a supporting frame 13 with a window-like opening for the passage of air, with the supporting frame 13 approximately corresponding in shape and size to the holding frame 3. The supporting frame 13 is part of the assembly member 1.

FIG. 4 shows the holding frame 3, again in the pivoted-away position, with the coolant cooler 9 having been pulled upward, partially out of the holding frame 3. The coolant cooler 9 is—as mentioned—embodied as a fully-aluminum heat exchanger and has two tank-shaped coolant tanks 9c, 9d which serve as guide strips. The longitudinal beams 3a, 3b have in each case one guide profile which is adapted in cross section to the coolant tanks 9c, 9d, so that the coolant cooler 9 is guided rectilinearly in the manner of a drawer when being inserted and pulled out.

FIG. 5 shows the holding frame 3 again in the pivoted-away position, with both the condenser 4 and also the coolant cooler 9 having been pulled substantially out of the holding frame 3 or the longitudinal beams 3a, 3b. On the longitudinal beam 3b, it is possible to see, at the inside, a guide rail 14 for the condenser 4 or its collecting tube 4a. The coolant cooler 9 is guided by means of a guide profile 15. The guide profiles or guide tracks in the longitudinal beams 3a, 3b are additionally embodied as sealing means, so that the heat exchangers 4, 9 are at the same time sealed off with respect to the holding frame 3.

It is clear from the above description that the heat exchangers, that is to say the condenser 4 and the coolant cooler 9, can be mounted and dismounted in a simple manner. Both mounting and dismounting take place when the holding frame 3 is pivoted away, so that the insertion opening 10 is exposed. After the insertion of the heat exchangers, the holding frame 3 is pivoted to and fastened, preferably clipped, to the assembly member 1 by means of the fastening elements 7. Dismounting takes place in the reverse sequence, that is to say detaching the fastening means, pivoting the holding frame 3 away and pulling the heat exchangers 4, 9 out.

### REFERENCE SYMBOLS

1 Assembly member (supporting structure with supporting frame)
2 Transverse member (lock member)
3 Holding frame
3a Longitudinal beam
3b Longitudinal beam
3c Transverse strut
3d Air guiding element
3e Air guiding element
4 Condenser
4a Collecting tube
5 Guide shaft
6 Pivot journal
7 Fastening means (clips)
8 Pivot bearing
9 Coolant cooler
9a Coolant connection
9b Coolant connection
9c Coolant tank
9d Coolant tank
10 Insertion opening
11 Fan opening
12 Rear wall (fan frame)
13 Supporting frame
14 Guide rail
15 Guide profile

1. A supporting structure in the front region of a motor vehicle having a supporting frame which can be covered at the rear side by a rear wall which has a fan opening, wherein a holding frame for holding cooling components, in particular heat exchangers, is pivotably arranged in front of the supporting frame in the direction of travel.

2. The supporting structure as claimed in claim 1, wherein the holding frame is pivotable about an approximately horizontally-running axis arranged at the bottom.

3. The supporting structure as claimed in claim 1, wherein parts of pivot bearings are arranged on the holding frame.

4. The supporting structure as claimed in claim 3, wherein the parts are formed as pivot journals which project laterally from the holding frame.

5. The supporting structure as claimed in claim 4, wherein U-shaped profiles for holding the pivot journals are arranged on the supporting frame.

6. The supporting structure as claimed in claim 1, wherein lateral fastening means for detachably fastening the holding frame to the supporting frame are arranged on the holding frame, preferably, in the upper region which can be pivoted out.

7. The supporting structure as claimed in claim 1, wherein the holding frame has laterally arranged guide elements, in particular guide rails for holding at least one heat exchanger.

8. The supporting structure as claimed in claim 1, wherein the holding frame has, on its upper side, an insertion opening through which the at least one heat exchanger can be inserted into the holding frame in the direction of the pivot axis and can be removed again in the opposite direction.

9. The supporting structure as claimed in claim 1, wherein a guide shaft for holding a further heat exchanger is arranged in the holding frame in the region of the pivot axis.

10. The supporting structure as claimed in claim 9, wherein the further heat exchanger, in particular a charge-air cooler, can be inserted into the guide shaft transversely with respect to the other heat exchangers.

11. The supporting structure as claimed in claim 1, wherein the heat exchangers can be sealed off at their periphery with respect to the holding frame.

12. The supporting structure as claimed in claim 1, wherein the holding frame can be sealed off at the end side with respect to the supporting frame.

13. The supporting structure as claimed in claim 1, wherein one of the heat exchangers is embodied as a coolant cooler, in particular as a fully-aluminum heat exchanger.

14. The supporting structure as claimed in claim 1, wherein one of the heat exchangers is embodied as a refrigerant condenser for an air-conditioning system.

15. The supporting structure as claimed in claim 1, wherein the holding frame can substantially be pivoted into two positions, specifically into a first, pivoted-away position and a second, pivoted-to position.
